(19) United States
(12) Patent Application Publication
(10) Pub. No.: US 2003/0067702 A1
(43) Pub. Date: Apr. 10, 2003

(54) Display on cartridge for storage medium

(76) Inventors: Nicholas John Iles, Chester (GB); Arthur Cheumin Woo, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/247,759

(22) Filed: Sep. 23, 2002

(30) Foreign Application Priority Data
Sep. 21, 2001 (GB) 0122905.3

(51) Int. Cl. G11B 15/18

(52) U.S. Cl. 360/69

(57) ABSTRACT

A data storage cartridge comprises a casing including (1) a data storage medium for storing data; (2) a memory device configured to store fields of information; (3) an electric power supply delivery device for supplying electric power to the memory device; and (4) a display for displaying the information fields. The display receives electric power from the electric power supply delivery device.

### FIELD OF THE INVENTION

The present invention relates to the field of cartridges for data storage media.

### BACKGROUND OF THE INVENTION

In order to store digital electronic data, it is known to use magnetic tape data storage cartridges which are inserted into a tape drive unit having a plurality of read/write heads. Typically, such magnetic tape storage devices are used to back-up data generated by a host device such as a computer or server.

In order to improve ease of access to data recorders on tape, it is known to include a solid state memory device within the cartridge and to store in this memory information relating to, for example, a listing of the contents of the tape.

In particular, in EP 0,646,914, there is realized an analog data recording video cassette of the type in which data is recorded in a plurality of scans across a width of the tape by a rotating record head, and which includes a memory device which can be configured to store fundamental information concerning the cassette and its contents, such as a table of contents or the like. In EP 0,646,914, the information concerning the cassette and its contents is transferred from a VCR tape drive unit to the video cassette through a set of metallic terminals provided on the cassette, wherein the contacts make electrical and physical contact with a corresponding set of metallic terminals on the VCR drive unit.

In EP 0,580,434, there is disclosed a VCR recording medium cartridge, wherein video data is stored in a plurality of diagonal scan passes across a width of the tape, by a rotating write head, and which includes a memory circuit for storing information concerning signals recorded on the recording medium within the cartridge. At least some of the data stored within the memory circuit can include the starting and ending positions of signals recorded on the recording medium and these starting and ending positions are recorded in the memory circuit at substantially the same time as recording to the recording medium. However, in EP 0,580,434 using an EEPROM memory, long write times are encountered, whereas use of a flash memory leads to long accessing times.

In WO 89/10615, there is disclosed a cassette containing a recording medium for storing computer generated data. The cassette includes a storage device for storing directory information concerning the contents of the tape. The storage device comprises a non-volatile random access memory and associated microprocessor and is accessed by either inductive coupling or electrical contact pads.

In U.S. Pat. No. 4,338,644 there is disclosed a cassette containing a recording medium which also includes within the housing an electronic memory and semi-conductor circuits for storing data relating to the cassette or tape therein.

EP 0,640,972 discloses a video tape cassette containing a memory device which can be used to store information concerning the contents of the information recorded on the video tape, such as time of recording, position and the like.

As data recording technology develops and the density of data written onto tapes and other suitable recording media increases, it becomes increasingly imperative to improve both data access times and tape/media reliability.

With prior art data storage media cartridges, having a cartridge memory, reading of the content of the memory requires a user to purchase a special reader, or to have a reader incorporated in a tape drive unit. To view the content of the cartridge memory, the user must place the cartridge in the reader or tape drive unit, in order to generate a display of information stored on the memory in the cartridge. This means firstly that a user must have access to a reader device or tape drive unit having a reader device, which introduces a cost barrier to reading the cartridge memory in prior art systems. Further, inserting the cartridge into the reader or tape drive unit is time consuming and not as quick as reading a hand written sticky label adhered to a side of a media cartridge.

Improvements are therefore desired to improve access to information stored in memories of data storage media cartridges. In particular, it is desired to develop methods and apparatus for retrieving information from cartridge memories of the type described such that either an improved cartridge memory reader is provided or a mechanism is provided whereby such a memory reader is not required.

According to one feature of the present invention, there is improved accessing of data written in high data density media. In particular, improved accessing results from simplifying procedures for determining exactly what data are present on a given data storage media cartridge such as a magnetic tape cartridge.

An object of the present invention is to provide a data storage media cartridge, of a type usable for computer back-up for example, in which data present on the given medium are readily identifiable using mechanisms present in the data storage media cartridge.

A further object of the present invention is to enable data stored on a data storage media cartridge to be read without the use of an external data storage device.

### SUMMARY OF THE INVENTION

According to one aspect of the present invention, a data storage media cartridge comprises a casing containing (1) a data storage medium for storing data, (2) a memory device for storing fields of information, (3) an electrical power supply delivery device for supplying electrical power to said memory device, and (4) a display for displaying the information fields. The display is configured to receive electrical power from the electrical power supply delivery device.

In another aspect of the present invention there is provided a method of making a data storage media cartridge having a casing and a data storage medium for storing data. The method comprises (1) providing the data storage media cartridge with a memory for storing fields of information, (2) providing the data storage media cartridge with a display for displaying the stored information fields, (3) providing the data storage media cartridge with an electrical power supply delivery device to enable the display and memory to receive electrical power, and (4) providing the data storage media cartridge with an activator for the display to cause display of the stored information fields.

Another aspect of the present invention relates to a method of operating a data storage media cartridge having a casing that contains (1) a data storage medium for storing data, (2) a memory device configured to store fields of information, (3) a signal receiver, and (4) a display. The method comprises reading the information by receiving with the receiver a signal to display the information, and displaying the stored information on the display in response to the received signal.

In a further aspect of the present invention, there is provided a rack-type device for holding at least one data storage media cartridge having a memory and a display. The device comprises a power supply delivery device for supplying power to the display and memory while the data storage media cartridge is in position on the rack device.

In this specification and the claims, the term “data storage device” includes a device capable of reading and/or writing data to a data storage media cartridge. A data storage device is capable of engaging a data storage media cartridge for transfer of data between the data storage device and the data storage media cartridge. A data storage device is capable of transferring data with a plurality of individual data storage media cartridges, either in parallel at the same time, and/or sequentially, i.e., one after another.

In this specification and the claims, the term “data storage media cartridge” includes any data storage media which, in normal use, provides for self contained storage of data, and can be stored or kept independently of a data storage device. Data can be read and/or written to a data storage media cartridge using a data storage device. The data storage media cartridge is engageable with one or more different data storage devices at different times, and is removable from each data storage device. The term media cartridge is to be construed as having a meaning equivalent to a data storage media cartridge.

Specific apparatus and methods described herein are concerned with magnetic tape data storage cartridges for use with magnetic tape recording devices having a substantially static read/write head in which an elongated tape is drawn past the head at relatively high speed, for example on the order of 3 meters per second. However, the apparatus and methods disclosed, and as identified in the claims herein, are not limited to use with static head devices, or devices having high tape speeds. Further, it will be apparent to those skilled in the art that the specific methods and constructions described herein are applicable to any media cartridge which is removable from a data storage device, and including, but not limited to, media cartridges such as magnetic random access memory (MRAM) modules, removable hard disk drives, removable programmable read only memory (PROM) modules, removable electrically programmable read only memory (EPROM) and electrically erasable programmable read only memory (EEPROM) modules.

In the specific structures and methods described and shown, reading and writing of data onto a magnetic tape can be carried out in both forward and reverse pass directions of the tape relative to a tape device read/write head, and a plurality of parallel data tracks can be read or recorded onto the tape simultaneously in a direction along the length of the tape using a read/write head comprising a plurality of spaced apart read/write elements. The media are permanently stored within a data storage cartridge which is removable from a data storage device, such as a tape drive mechanism.

### BRIEF DESCRIPTION OF THE DRAWING

For a better understanding of the invention and to show how the same may be carried into effect, there will now be described by way of example only, specific embodiments, methods and processes according to the present invention with reference to the accompanying drawings in which:

FIG. 1 is a perspective view of a prior art tape data storage media cartridge 100 having a memory for storing information concerning signals recorded on a recording medium such as a magnetic tape;

FIG. 2 includes side and top views of portions of the tape data storage media cartridge of FIG. 1 indicating the position of a memory located in the cartridge;

FIG. 3 is a block diagram of a known read/write device configurable for writing data to a memory of a magnetic tape data storage media cartridge;

FIG. 4 is a schematic illustration of a known layout of data within a cartridge memory as obtained from the apparatus illustrated in FIG. 3;

FIG. 5 is a perspective view of a tape data storage cartridge according to a first specific embodiment of the present invention;

FIG. 6 is a block diagram of apparatus included in the cartridge of FIG. 5 for enabling (1) data to be written a cartridge memory and (2) convenient and ready display of the data content of the recording medium to a user;

FIG. 7 is a flow diagram of processing steps undertaken by the device illustrated in FIGS. 5 and 6 following receipt of various types of processing requests including a request to display information concerning data content of the recording medium included within the data storage cartridge;

FIG. 8 is a flow diagram of step 704 of FIG. 7 relating to displaying information content of a recording medium;

FIG. 9 is an illustration of successive display screens viewed by an operator of the device of FIG. 5 when the device operates according to the steps of FIGS. 7 and 8; and

FIG. 10 is a perspective view of an alternative preferred embodiment comprising a storage rack to power one or more display devices located respectively on one or more data storage media cartridges placed in the storage rack.

### DETAILED DESCRIPTION OF THE DRAWING

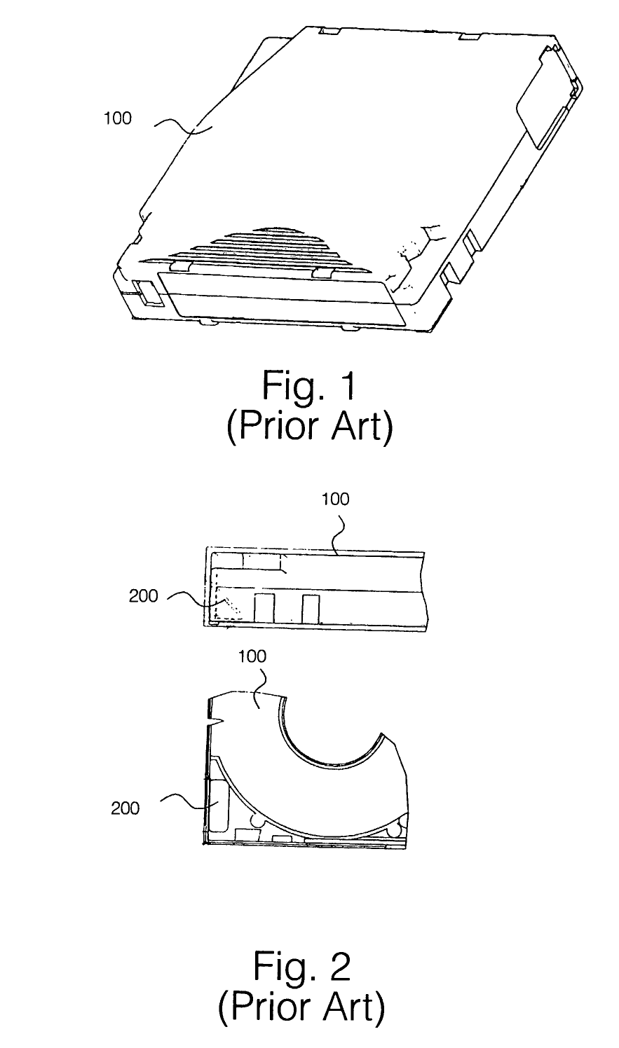

Referring to FIG. 1 herein, there is schematically illustrated a prior art tape data storage cartridge 100, comprising: a case; automation notches; handling notches; a write inhibit mechanism; a single reel for storing magnetic tape; a locking mechanism for the reel; a magnetic tape wound on the hub of the reel; a leader pin; a parking mechanism for the leader pin; a door; and a memory device located within the casing. Before the tape is inserted into a data storage device, such as a tape drive, the tape is usually wound fully onto a reel inside the cartridge. To access data on an end of the tape nearest the reel, the tape must be substantially fully wound out of the cartridge and onto a second reel of a tape drive mechanism. Before the cartridge is removed from the tape drive, the tape must be fully rewound back onto the reel inside the cartridge. If information as to the data content of the cartridge is required readily, there is no immediate mechanism available to enable the required information to be obtained by a user in a convenient and efficient manner.

Referring to FIG. 2, there are illustrated two views of a section of tape data storage cartridge 100 indicating the approximate position and orientation of a memory device 200 in the case. The memory device 200 is positioned near the periphery of the casing and within the casing such that as the cartridge is inserted into a suitably configured tape drive unit, signals can be read and written to the memory device 200 by inductive coupling.

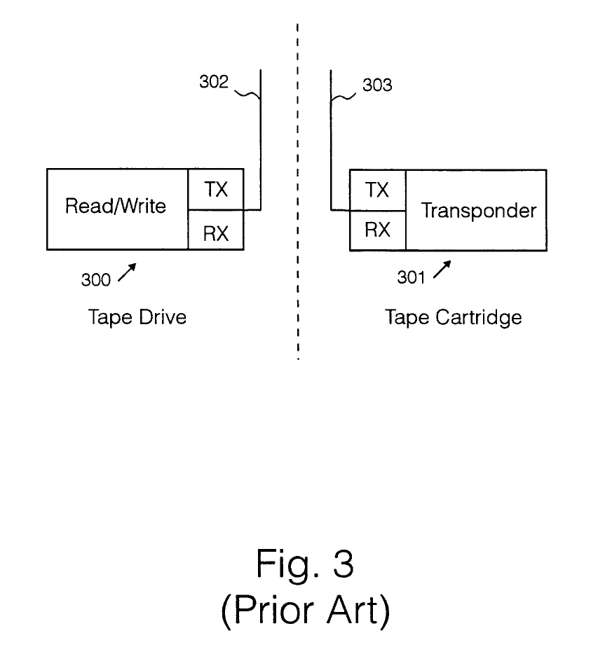

Referring to FIG. 3, there is illustrated schematically, in block diagram form, a known read/write device 300 including a first transceiver having a wireless transmitter TX and a receiver RX connected to antenna 302 for writing data to a transponder unit 301 of a magnetic tape cartridge memory. As is known to those skilled in the art, device 300 is incorporated into a tape drive mechanism such that when a tape cartridge is inserted into the tape drive mechanism, a transponder device 301 incorporated within the data cartridge can be inductively powered and signals can be received and sent between the device 300 on the tape drive and the transponder 301 in the cartridge. Transponder 301 includes a second transceiver having a wireless transmitter TX and receiver RX connected to an antenna 303. Signals are exchanged by the receivers and transmitters of device 300 and transponder 301 via respective antennae 302 and 303. As is known to those skilled in the art, the tape drive transmitter/receiver based read/write unit 300 comprises: a serial interface to a suitably configured tape drive; a processor; a transmitter and receiver; an antenna 302 and a crystal oscillator for generating the required radio-type signals. The memory device utilized within the tape drive unit typically comprises an Electrically Erasable Programmable Read Only Memory (EEPROM). A known tape cartridge 301 configured to transmit signals to and receive signals from tape drive 300 comprises a transmitter, a receiver, an antenna 303, a processor and a crystal oscillator. The read/write device 300 and the transponder unit 301 of a tape cartridge exchange information using a contactless interface via the antennae 302 and 303 respectively. A protocol used to transmit information via inductive coupling is the known MIFARE® system developed by Philips/Micron as is currently employed in “Smart” card technology used in personal banking applications. Other protocols/mechanisms may be utilized although the features of this system include high reliability, operating frequency of 13.56 MHz and the ability to handle several data storage cartridges within an operating field of a single data storage device. Typically, distances between antennae 302 and 303 are on the order of less than or equal to 20 mm for optimum performance. Components of transponder 301 can readily be implemented as Application Specific Integrated Circuits (ASIC) and the memory comprised within transponder unit 301 can suitably be implemented as an EEPROM having a total capacity of 4 kilobytes, organized as 28 blocks of 32 bytes each. Access to memory blocks is controlled using write protection. Write protection means that the access condition to the specified memory block is switched from read and write to read only. Typically, the memory within or used in conjunction with transponder unit 301, and located within the tape cartridge, is designed to be read an unlimited number of times and to be able to undergo up to 500,000 write cycles. As is known to those skilled in the art, the power for operating transponder unit 301 would usually be derived from an external source, for example from the tape drive itself or through some other suitable arrangement.

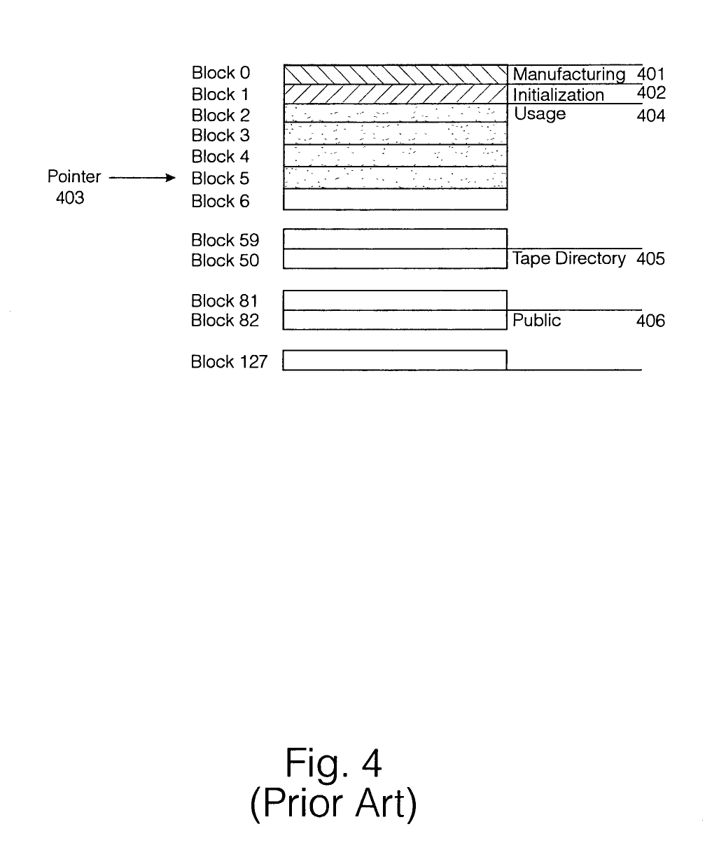

FIG. 4 is a schematic illustration of a possible known layout of data within a cartridge memory as obtained by utilizing the known apparatus shown in FIG. 3. In FIG. 4, there is a schematic illustration of a logical arrangement of data within a memory device located within, or at least used in conjunction with, transponder unit 301. Various types of write protection can be used including:

Write protection in test flow: a manufacturing block 401 is protected with 3 bits in block 0, and can only be read after test;

Write protection with 1 bit: an initialization block 402 is write protected with 1 bit which is stored in the initialization block;

Write protection by means of a pointer 403: blocks of memory are, for example, allocated to usage 404, tape directory 405 and public 406 and are divided between one write protected region and one non-write protected region. The border between these regions is indicated by a pointer which stores the address of the last protected block. The pointer itself, as those skilled in the art will appreciate, is stored in the initialization block 402. The pointer is irreversibly set when the initialization block is write protected.

Further details concerning how the number of blocks within the EEPROM are allocated to specific sections indicating the content of the information stored therein and the amount of memory in bytes allocated to each section are somewhat application specific and in any case known to those skilled in the art. Thus, these details will not be further discussed in the present application.

Although a known cartridge memory of the type illustrated in the preceding figures is capable of storing vast amounts of data and enables data to be retrieved using a cartridge reading device, the cartridges are not readily usable by a user who wishes to ascertain in a fairly efficient and convenient manner exactly what data is present on the cartridge.

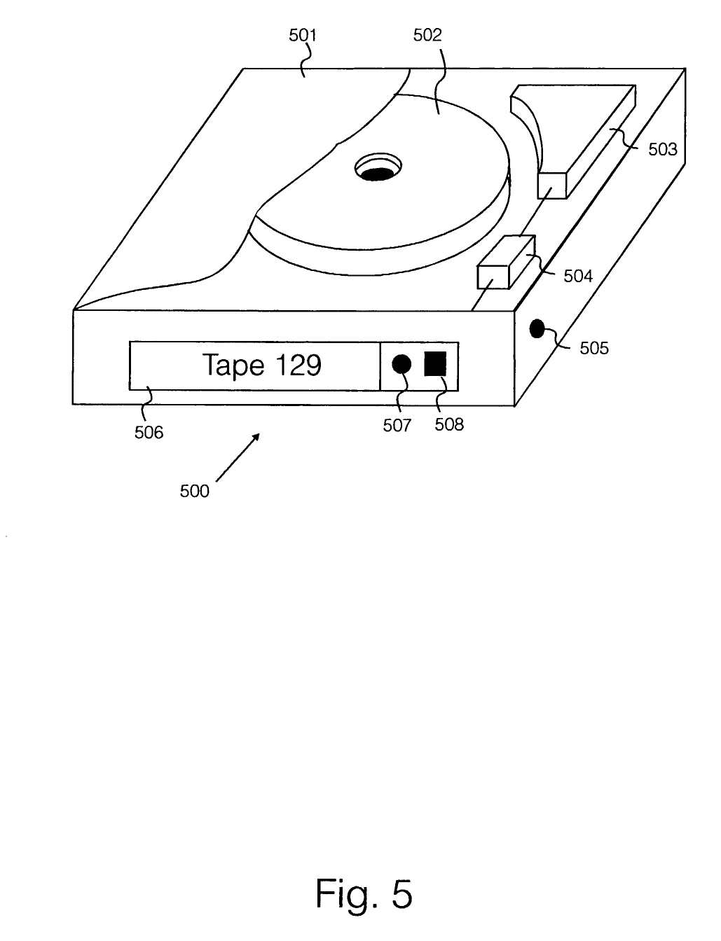

In the following description of FIGS. 5-10, numerous specific details are set forth in order to provide a thorough understanding of the structures of these Figs. It will be apparent, however, to one skilled in the art, that the present invention can be practiced without limitation to the specific details of FIGS. 5-10. In other instances, well known methods and structures have not been described in detail so as not to unnecessarily obscure the description of FIGS. 5-10.

FIG. 5 is a perspective, partially cut away view of a tape data storage cartridge 500 based on the cartridge described in relation to FIGS. 1 to 4. The cartridge of FIG. 5 enables a user of the cartridge to more readily access information concerning data content on a tape medium than the cartridge of FIGS. 1-4. Cartridge 500 comprises a casing 501, containing a magnetic tape 502 rotatable about an axle and the other components listed in relation to cartridge 100 described in FIG. 1. In particular, casing 501 of tape data storage cartridge 500 carries transponder unit 503 electrically connected to cartridge memory 504, units 503 and 504 operating substantially in accordance with the description given for transponder unit 301 in FIG. 3. Further improvements to data storage cartridge 100 are illustrated for the improved cartridge 500. Thus, although cartridge 100 may comprise an electrical power supply delivering device of some sort, casing 501 of cartridge 500 specifically includes an electrical power supply delivery device to power an electrically operated display 506. Display 506 can suitably comprise a Liquid Crystal Display (LCD) which is in electronic communication with a memory that stores information on the data content of magnetic tape 502. The memory storing information about the data content of tape 502 can be either a dedicated memory (not shown) which is in electronic communication with memory 504 or a portion of memory 504 can be utilized for this purpose. Relevant data stored in memory 504 can be accessed by a user of cartridge 500 in response to the user pressing a display on/off button 507. Various fields of information, some of which can be identified by an appropriate stored descriptive identifier concerning a particular item of data stored on magnetic tape 502, can be stepped through by using step through control button 508.

Power is supplied to electrical and electronic components in casing 501 by a source within or external to the casing by a power supply delivery device 505 that can take various forms as will be readily apparent to those skilled in the art. For example, a small battery or a solar cell, for example, can be used to power display panel 506. Alternatively, a capacitor can be incorporated in the device which can be charged in some suitable manner such as by use of a high frequency radio-type link in response to storage of the cartridge in a tape drive device.

The power supply delivery device 505 could conveniently comprise a tape drive data storage device that is the charging device for charging a battery or a capacitor located within casing 501 of a given cartridge. This latter embodiment is advantageous since cartridges are frequently located in a drive for a relatively long period of time. Therefore, it is clearly beneficial to recharge a battery located within a given cartridge while it is in place in a given tape drive. An additional advantage of using a tape drive to charge a battery or other similar device located within casing 501 of a given cartridge is that a separate structure is not required; all that is required is a tape drive and one or more media cartridges for use in the tape drive.

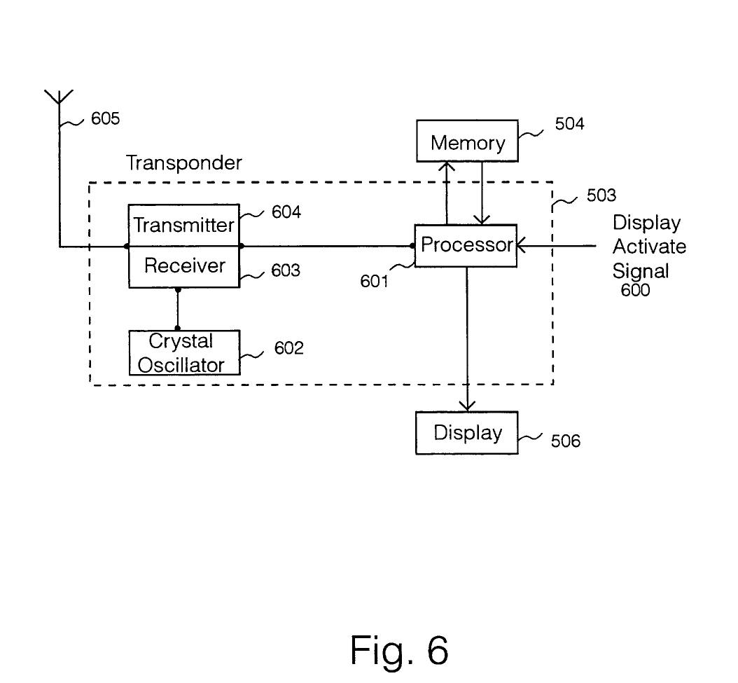

FIG. 6 is a block diagram of the apparatus included in the media cartridge of FIG. 5. The apparatus of FIG. 6 is configured to both write data to a cartridge memory in which the cartridge is located and to enable convenient and ready display of the data content of the recording media to a user. The media cartridge, as illustrated in FIG. 6, comprises transponder unit 503, memory 504 and display 506. Display 506 is activated by a display activate signal 600 transmitted to processor 601 of transponder 503. Activate signal 600 is invoked by a user pressing a button, such as button 507 of the cartridge illustrated in FIG. 5, or can automatically be generated within processor 601 upon an appropriate power source being activated to responsively power the screen of display device 506. Transponder unit 503 also comprises radio-type signal transmitter crystal oscillator 602, receiver 603, transmitter 604 and antenna 605. As those skilled in the art will realize, further embodiments can be envisaged which do not integrate the display, processing/memory functions with the known transponder arrangement. However, the integrated arrangement is considered to reduce costs of manufacture as compared to the usage of separate components.

The transponder 503, memory 504 and display 506 form part of an electronic circuit contained within the cartridge. The display of a given cartridge can be activated to display required information stored in the cartridge memory by: (1) button activation alone, (2) only in response to the cartridge being located in the tape drive, or (3) button activation in response to the cartridge being located in tape drive activation.

To drive the LCD display, an LCD driver (not shown) is provided in the casing 501 and is connected to the circuit of FIG. 6 as will be apparent to those skilled in the art. Similarly, for button activation of the circuit, a battery or other suitable power source in casing 501 is provided with provisions for recharging. The function of the circuit, in terms of button activation, is to sense the activation of the button and display information as appropriate on the LCD screen of display 506. Similarly, for the activation of a cartridge in tape drive, the function of the circuit is to accept commands from the tape drive to the interface of the cartridge, and display information as appropriate on the LCD screen. In an embodiment comprising both button activation and activation in response to a cartridge being in a tape drive, the information displayed depends on whether information is requested by the user activating the button or following a command having been received by the tape drive via the interface of the cartridge.

In the case of button activation, the cartridge is assumed to be not in a tape drive. Using power stored in the battery, the circuit fetches data from the cartridge memory and displays it with suitable annotation in a prioritized order. An example of such a prioritized list is as follows:

1. Volume label

2. Date and time

3. Amount of data stored, free space available

4. Data source

5. Protection levels

In the case of activation in response to the cartridge being in a tape drive, the LCD panel can be used as a message window for the tape system displaying data such as:

1. Drive mode (rewind, write, idled, etc.)

2. Error conditions

3. Time to job completion/percentage job complete

4. Position information for robotics in library

5. Inventory information in machine format, i.e., bar code (suitable for library sensors)

The above example lists of possible data for display are, as indicated, not to be considered to be limited to the individual exemplary items denoted since many other types of displayed information and data can also be beneficial to a user of a given tape drive system.

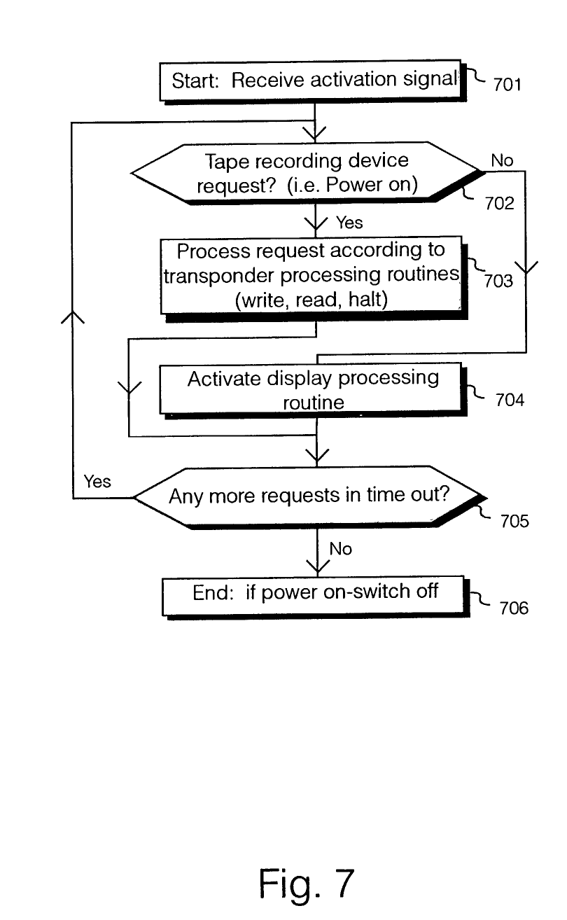

FIG. 7 is a flow diagram of processing steps undertaken by the cartridge illustrated in FIGS. 5 and 6 following receipt of various types of processing requests including a request to display information concerning the data content of the recording medium within the data storage cartridge.

In the process illustrated in FIG. 7, the functions of transponder 503 and display 506 are within a single unit as discussed above. At step 701, processor 601 of transponder unit 503 is activated in response to receipt of an activation signal 600 instructing the processor to undertake an appropriate action. At step 702, processor 601 determines whether or not the activation signal was transmitted from a tape recording device (via antenna/receiver arrangement 605, 603) or whether the request results from a display activation signal 600. As described, signal 600 can be generated by a user pressing a suitably configured button to activate display 506 or it can be generated in some other suitable manner. If the question asked at step 702 is answered in the affirmative, processor 601 determines that the activation signal has been generated by a tape recording device and therefore processes the request thereafter at step 703 according to transponder processing routines as required—these include write, read, halt and so on. Following step 703, the process advances to step 705 wherein processor 601 is configured to ask a further question as to whether any more requests have been received in a given time out. If a further request has been received, the process returns to step 702 and steps 702-705 are repeated. However, if the question asked at step 705 is answered in the negative, the process advances to step 706, during which the process is effectively terminated and a power on switch (if there is one) is switched off. Switching off the power in this way is preferable, particularly if a stand alone cartridge having its own battery is used, to avoid unnecessary battery power usage.

Returning to step 702, if the question is answered in the negative, the process advances to step 704 wherein processor 601 is configured to activate a display processing routine and display information, comprising a descriptive identifier and, where applicable, associated data as required by a given user. The display function can include a user being able to step through given fields of information or alternatively can comprise an automatic run through of stored information fields, each field being displayed for a certain amount of time before the next field. Following processing at step 704, the process advances to step 705 wherein the question is asked as to whether or not any more requests have been received in a given time out. If the question is answered in the affirmative, the process returns to step 702 and steps 702-706 are repeated or, if the answer is answered in the negative, the process advances to step 706 and the process is terminated.

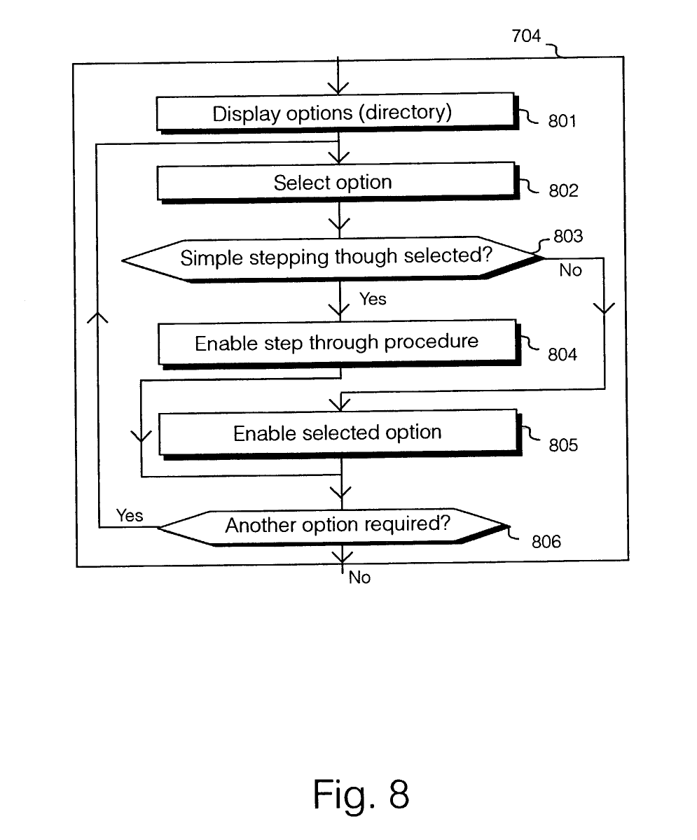

FIG. 8 includes specific operations of step 704 of FIG. 7 relating to displaying information describing the information content of the given recording medium with which a given display is used. The processing steps of FIG. 8 enable the user to select particular options in relation to viewing data as required. Following step 702, at step 801 processor 601 is configured to display pre-configured options to a user of the cartridge memory. Thus, at step 801, a main page directory option is presented. At this point, the user can assess which option she/he requires and thereafter, at step 802, the user selects the desired option by pressing control button 508 and thereafter the user steps through the presented options. Various options can be configured in accordance with a given manufacturer's and/or user's requirements, such as the option of simple stepping through the information fields stored in memory 504, or enabling the user to select an option to search the memory and find a required item of information for viewing. Following step 802, processor 601 is configured to advance to step 803, wherein a question is asked as to whether simple stepping through the information fields is to be performed. If the question of step 803 is answered in the affirmative, the process advances to step 804 at which point the procedure for enabling simple stepping through the information fields is invoked. Simple stepping through the information fields involves the user repeatedly pressing control button 508 to continuously step through successive information fields and might involve the user pressing button 508 twice to terminate the procedure. Either upon stepping through all fields or upon termination of procedure 804, the process then advances to step 806, wherein processor 601 is configured to ask a further question as to whether or not the user wishes to select any further options. If the answer to the question asked at step 806 is in the affirmative, the process returns to step 802 and steps 802-806 are repeated accordingly. Returning to step 803, if the question asked at step 806 is answered in the negative, the process advances to step 705 as previously described. However, if the question asked at step 803 is answered in the negative, the process advances to step 805 wherein the appropriate procedure relating to the selected option is invoked and the user prompted accordingly, if required, for further selections to be made, to exit the procedure or to simply view the information displayed and then exit, etc. Following step 805, the process advances to step 806 and the procedure comprising steps 802-806 is repeated if the question is answered in the affirmative or terminated if answered in the negative.

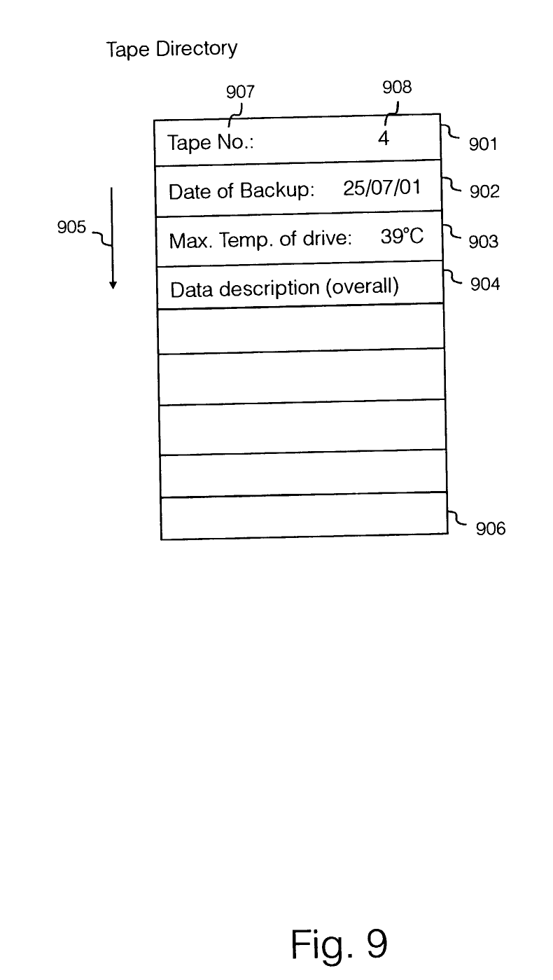

FIG. 9 is a schematic illustration of successive display screens as stepped through by an operator of the media cartridge of FIGS. 5 and 6 that is operating according to the steps detailed in FIGS. 7 and 8. Thus, a suitably configured tape directory 405 comprises various fields of information required to be stored in memory 504. For example, memory 504, in relation to the display function, might comprise: tape number field 901; date of back-up field 902; field 903, which indicates maximum temperature of the tape drive reached during a given operation such as back-up; and overall data description field 904. For the sake of illustration, the operator sequentially steps through the displayed fields 901, 902, etc., as indicated by vertical arrow 905, until the final field is reached. As those skilled in the art will realize, a variety of types of useful and appropriate data might be stored as described and stepped through for convenient viewing of tape content on LCD display 506. For a given information field, an identifier can be displayed along with the associated stored data where appropriate. Thus, for example, in field 901 a descriptive identifier 907 “Tape No.” is associated with data 908 which in the example comprises the numeral “4” indicating that the number of the data storage device (tape) is “4”.

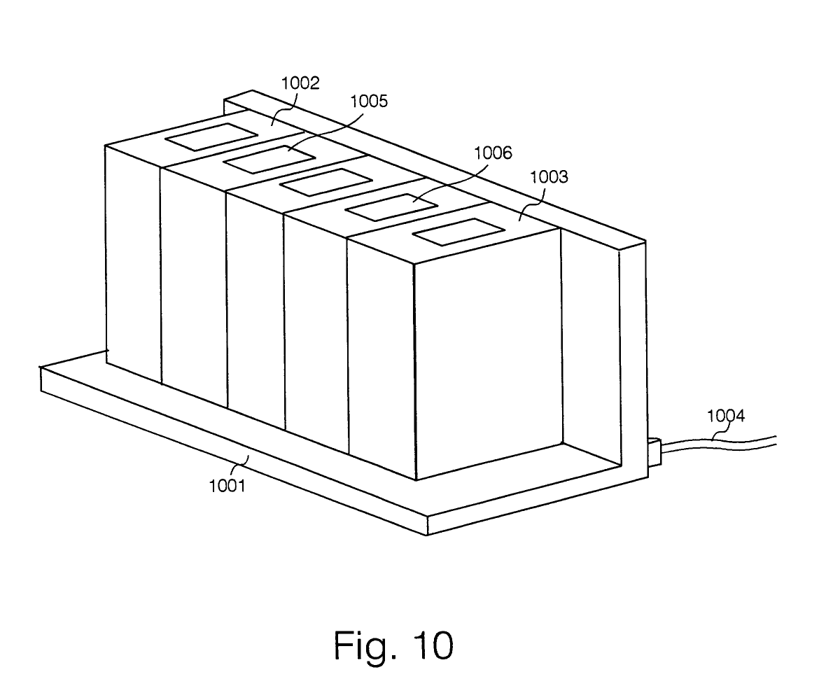

FIG. 10 is a perspective view of an alternative arrangement wherein a storage rack powers one or more display devices, each located respectively on one or more data storage tape devices located in the power delivery storage rack. Power delivery supply rack 1001 comprises a flat base and a back portion positioned perpendicular to the base. In the rack are located data storage cartridges 1002, 1003, etc. The rack is powered by an electrical power supply mains lead 1004. Alternatively, the rack is battery powered. In this way, a plurality of data storage cartridges are energized at the same time and the displays on each cartridge, 1005, 1006, can be read by a person interested in determining the general content of each given cartridge.

The devices illustrated in FIGS. 5-10 provide an improved ease of access to information stored on a memory device within a media cartridge. A user can simply pick up a media cartridge, and view a display of data contained on a memory device within a cartridge, without the need for a special reader device, or expensive tape drive unit containing a reader device. Manipulation and handling of the devices of FIGS. 5-10 to view a data content of a cartridge memory, is quicker and more convenient, than in prior art cartridges having memory devices which can only be read via a reader or suitably equipped tape drive unit.

Those skilled in the art will realize that various modifications and improvements to the devices and methods described may be made, which fall within the scope of the present invention as determined by the claims.

1. A data storage cartridge comprising:
a casing including (a) a data storage medium for storing data; (b) a memory device configured to store fields of information; (c) an electrical power supply delivery device configured to enable electrical power to be supplied to said memory device; and (d) a display configured to receive electrical power from said electrical power supply delivery device and signals from the memory device, said display and memory device being arranged to cause display of said information fields, wherein said information fields are selected from a set of information fields comprising:
data storage device number;
data of back-up;
maximum temperature of a data storage device encountered during a data back/up procedure;
volume label;
date and time;
amount of data stored, free space available;
data source; and
protection level.

2. A data storage cartridge as claimed in claim 1, wherein said display comprises an LCD display.

3. A data storage cartridge as claimed in claim 1, wherein said data storage medium comprises a magnetic tape.

4. A data storage cartridge as claimed in claim 1, wherein said electrical power supply delivery device comprises an electrical power generation device located within said casing.

5. A data storage cartridge as claimed in claim 1, wherein said electrical power supply delivery device comprises a battery.

6. A data storage cartridge comprising:
a casing including (a) a data storage medium for storing data; (b) a memory device configured to store fields of information; (c) an electrical power supply delivery device configured to enable electrical power to be supplied to said memory device; and (d) a display device configured to receive electrical power from said electrical power supply delivery device and signals from the memory device, said display device and memory device being arranged to cause the display of said information fields, wherein said information fields are selected from a set of information fields comprising:
drive mode selected from the set of modes comprising rewind, write and idled;
error conditions;
time to job completion or percentage job completion;
position information for robotics in a library of data storage media cartridges; and
inventory information in machine format.

7. A data storage cartridge as claimed in claim 6, wherein said display comprises an LCD display.

8. A data storage cartridge as claimed in claim 6, wherein said data storage medium comprises a magnetic data storage tape.

9. A data storage cartridge as claimed in claim 6, wherein said electrical power supply delivery device is configured to receive electrical power from a media drive into which said data storage media cartridge is configured to be inserted.

10. A data storage cartridge comprising:
a casing including (a) a data storage medium for storing data; (b) a memory device configured to store fields of information; (c) an electrical power supply delivery device configured to enable electrical power to be supplied to said memory device; and (d) a display device configurable to receive electrical power from said electrical power supply delivery device and signals from the memory device, said display and memory devices being arranged to cause the display to step through and display said information fields to a user of said media cartridge.

11. A data storage cartridge as claimed in claim 10, wherein said stepping through of said information fields is controlled by a user using a control device provided on said casing.

12. A data storage cartridge as claimed in claim 10, wherein said stored fields of information are selected from a set of information fields comprising:
data storage device number;
date of back-up;
maximum temperature of said data storage device encountered during a data back-up procedure;
volume label;
date and time;
amount of data stored, free space available;
data source; and
protection levels.

13. A data storage cartridge as claimed in claim 10, wherein said control device comprises a button.

14. A data storage cartridge as claimed in claim 10, wherein said electrical power supply delivery device comprises a battery.

15. A data storage cartridge as claimed in claim 10, wherein said display device comprises an LCD display.

16. A data storage cartridge as claimed in claim 10, wherein said stepping through of said information fields is activated in response to a media drive on said cartridge being located in said drive.

17. A data storage cartridge as claimed in claim 10, wherein said information fields are selected from a set of information fields comprising:
drive mode selected from the set of modes comprising rewind, write and idled;
error conditions;
time to job completion or percentage of job complete;
position information for robotics in a library of data storage media cartridges; and
inventory information in machine format.

18. A data storage cartridge as claimed in claim 10, wherein said display is arranged to display each of said information fields along with a descriptive identifier to identify said displayed information.

19. A data storage cartridge as claimed in claim 10, wherein said display is arranged to display said information fields along with a descriptive identifier to identify said displayed information, said information fields being displayed in a prioritized order.

20. A data storage cartridge comprising:
a casing including (a) a data storage medium for storing data; (b) a memory device configured to store fields of information; (c) an electrical power supply delivery device configured to enable electrical power to be supplied to said memory device; (d) a display device configured to receive electrical power from said electrical power supply delivery device, said display being configured to display said information fields; and (e) a transponder unit associated with an antenna, said transponder unit being configured to send signals to and receive signals from a transmitter/receiver on a media drive into which said cartridge is configured to be inserted.

21. A data storage cartridge as claimed in claim 20, wherein said display device comprises an LCD display.

22. A data storage as claimed in claim 20, wherein said display device comprises an LCD display for displaying information concerning a said media drive system into which said cartridge is configured to be inserted.

23. A data storage cartridge as claimed in claim 20, wherein said data storage medium comprises a magnetic tape.

24. A data storage cartridge comprising:
a casing including (a) a data storage medium for storing data; (b) a memory device configured to store fields of information; (c) an electrical power supply delivery device configured to enable electrical power to be supplied to said memory device; and (d) a display device configured to receive electrical power from said electrical power supply delivery device and signals from the memory device, said display device and memory device being arranged to cause the display to display said information fields:
said display being configured to select a display processing routine from (i) the set comprising a routine activated by a user of said data storage media cartridge; and (ii) a display processing routine activated by a signal received from a media drive in which said media cartridge is located.

25. A data storage cartridge as claimed in claim 24, wherein:
said selection of a display processing routine activated by a media drive is invoked in response to a transponder unit located in said casing receiving a signal from said media drive; and
a display processing routine adapted to be selected in response to a user activating a control device located on said casing.

26. A data storage cartridge as claimed in claim 24, wherein said display device comprises an LCD display.

27. A data storage cartridge as claimed in claim 24, wherein said data storage medium comprises magnetic tape.

28. A method of making a data storage cartridge comprising a casing and a data storage medium for storing data, said method comprising:
providing said data storage media cartridge with a memory for storing fields of information;
providing said data storage media cartridge with a display for displaying said stored information fields;
providing said data storage media cartridge with an electrical power supply delivery device to enable said display and said memory to receive electrical power;
providing said data storage media cartridge with an activation controller for activating said display to display said stored information fields; and
providing said data storage media cartridge with field stepping with a controller to effect stepping through of said fields of information according to a pre-determined display processing routine.

29. A method of making a data storage cartridge as claimed in claim 28, wherein said activation controller comprises a user operated control.

30. A method of making a data storage cartridge as claimed in claim 28, wherein said stepping through controller comprises a user operated control, said user operated control being provided with an internal electrical power supply.

31. A method of making a data storage cartridge as claimed in claim 27, wherein said cartridge is provided with an electrical power supply delivery device for receiving electrical power from an external power source located in a media drive into which said data storage media cartridge is configured to be inserted.

32. A method of operating a data storage cartridge having:
a casing including (a) a data storage medium for storing data; (b) a memory device configured to store information; (c) an electrical power supply delivery device configured to enable electrical power to be supplied to said memory device; (d) a display; and (e) an electric signal receiver, the method comprising reading said information by
selecting an electrical power source to power said memory and said display from a set of power sources comprising:
an internal power source; and
an external power source;
receiving with the receiver an electrical signal commanding display of said information; and
displaying said stored information on said display in response to said received electrical display signal.

33. A method as claimed in claim 32, wherein said step of displaying said information comprises displaying said information on an LCD display.

34. A method as claimed in claim 32, wherein said selected internal power source comprises use of a battery located inside said cartridge.

35. A method as claimed in claim 32, wherein said reading of information comprises reading information fields selected from the set comprising:
data storage device number;
date of back-up;
maximum temperature of data storage device encountered during a data back-up procedure;
volume label;
data and time;
amount of data stored, free space available;
data source; and
protection levels.

36. A method as claimed in claim 32, wherein said information fields are displayed in a prioritized order.

37. A method as claimed in claim 32, wherein a said information field is displayed along with an information identifier.

38. A method as claimed in claim 32, wherein said selection of an external power source comprises powering of said cartridge from a media driver into which said media cartridge is configured to be inserted.

39. A method as claimed in claim 32, wherein said displayed information fields concern information relating to a media drive in which said cartridge is configured to be inserted.

40. A rack device configurable to hold at least one data storage cartridge having a memory and a display, said rack device comprising an electrical power supply delivery device for supplying electrical power to said display and to said memory while a said data storage cartridge is located in position on said rack device.

41. A rack device as claimed in claim 40, wherein said rack device is configured to simultaneously hold and supply electrical power to a plurality of said data storage cartridges.

42. A rack device as claimed in claim 40, wherein said rack device is configured to hold magnetic tape data storage cartridges.

43. A rack device as claimed in claim 40, wherein said rack device is configured to hold data storage cartridges having an LCD display and an internal electrical power supply.
